(19) United States
(12) Patent Application Publication
(10) Pub. No.: US 2024/0201758 A1
(43) Pub. Date: Jun. 20, 2024

(54) EXPANSION BOARD AND MAINFRAME APPARATUS

(71) Applicant: INNODISK CORPORATION, New Taipei City (TW)

(72) Inventors: CHUNJU WU, New Taipei City (TW); TINGHUANG WEI, New Taipei City (TW); TSUNGCHIA WU, New Taipei City (TW); HOHSIAO TUANMU, New Taipei City (TW)

(21) Appl. No.: 18/112,505

(22) Filed: Feb. 22, 2023

(30) Foreign Application Priority Data
Dec. 14, 2022 (TW) 111147885

(51) Int. Cl. G06F 1/18; G06F 13/40; H05K 1/14

(52) U.S. Cl. CPC G06F 1/185; G06F 13/409; H05K 1/141; G06F 2115/12

(57) ABSTRACT

An expansion board adapted to be electrically connected in parallel to a motherboard. The expansion board includes at least one group of connector pins and a processor. The at least one group of connector pins are coupled to a first connector that conforms to a first industrial specification to receive the transmission signal from the motherboard. Pin definitions of the at least one group of connector pins conform to pin definitions of a second industrial specification. The processor is coupled to the at least one group of connector pins to receive or send the transmission signal. Dimensions of the first connector are less than the dimensions of a second connector that conforms to the second industrial specification.

### CROSS-REFERENCE TO RELATED APPLICATION

This non-provisional application claims priority under 35 U.S.C. § 119(a) on Patent Application No(s). 111147885 filed in Taiwan, R.O.C. on Dec. 14, 2022, the entire contents of which are hereby incorporated by reference.

### BACKGROUND OF THE INVENTION

### 1. Field of the Invention

The present invention relates to a mainframe apparatus, and in particular to a mainframe apparatus comprising an expansion board for electrically connecting to a motherboard.

### 2. Description of the Related Art

Industrial computer products come in a wide variety, for example, embedded computers, single-board computers, industrial tablets, industrial motherboards, on-board computers, security monitoring motherboards, gambling console motherboards, game console motherboards, and industrial automation control motherboards. The single-board computers are each a complete computer built on a single circuit board. In general, the single-board computer can be equipped with an expansion board for further expanding its functions so as to be applicable to numerous fields, especially small-sized industrial computers.

Refer to FIG. 1, which is an exploded view of a conventional single-board computer with an expansion board. A conventional single-board computer 100 comprises a standalone motherboard 110 and an expansion board 120. The standalone motherboard 110 has a connector 112, such as a PCIe slot. The expansion board 120 has pins 122 corresponding in position to the connector 112. The pins 122 and the connector 112 conform to the same industrial specification. Thus, the expansion board 120 is insertedly disposed on the connector 112 via the pins 122 to exchange signals with the motherboard 110. The connector 112 can be a conventional board-to-board connector capable of high-speed transmission.

However, the conventional high-speed board-to-board connector takes up a lot of space above the motherboard or expansion board. Thus, the circuit layout on the motherboard 110 or the expansion board 120 on the conventional single-board computer 100 is regarded as less important than the area and position of the pins of the high-speed board-to-board connector, thereby leaving little room for customization.

### BRIEF SUMMARY OF THE INVENTION

The present invention provides an expansion board that can be electrically connected to a motherboard and adapted to save circuit board space and ensure high signal transmission speed.

The present disclosure further provides a mainframe apparatus which the expansion board is insertedly disposed on.

The expansion board of the present disclosure is adapted to be electrically connected in parallel to a motherboard. The expansion board comprises at least one group of connector pins and a processor. The at least one group of connector pins are adapted to be coupled to a first connector that conforms to a first industrial specification, so as to receive transmission signals from the motherboard. Pin definitions of the at least one group of connector pins conform to pin definitions of a second industrial specification. Furthermore, the processor is coupled to the at least one group of connector pins to receive or transmit the transmission signals. Dimensions of the first connector are less than dimensions of a second connector that conforms to the second industrial specification.

The mainframe apparatus of the present disclosure comprises a motherboard, at least one group of connector pins, and a processor. The motherboard is adapted to be electrically connected in parallel to an expansion board. The at least one group of connector pins are disposed at the motherboard and coupled to a first connector that conforms to a first industrial specification to receive a transmission signal from the expansion board. Pin definitions of the at least one group of connector pins conform to pin definitions of a second industrial specification. The transmission signal conforms to the second industrial specification. The processor is coupled to the at least one group of connector pins to receive or send the transmission signal. Dimensions of the first connector are less than dimensions of a second connector that conforms to the second industrial specification.

In some embodiments, the first connector is a USB Type-C connector, and the second industrial specification is a PCIe transmission specification.

In some other embodiments, the second industrial specification supports a plurality of transmission channels, and the pin definitions of the connector pins support at least one of the transmission channels, respectively.

The connector pins on the expansion board or the motherboard are coupled to the first connector of insignificant dimensions to not only to save space in an electronic device but also to ensure high signal transmission speed, so as to facilitate customization in terms of the trend toward light, small and thin electronic devices.

### BRIEF DESCRIPTION OF THE DRAWINGS

FIG. 1 is an exploded view of a conventional single-board computer with an expansion board of the prior art.

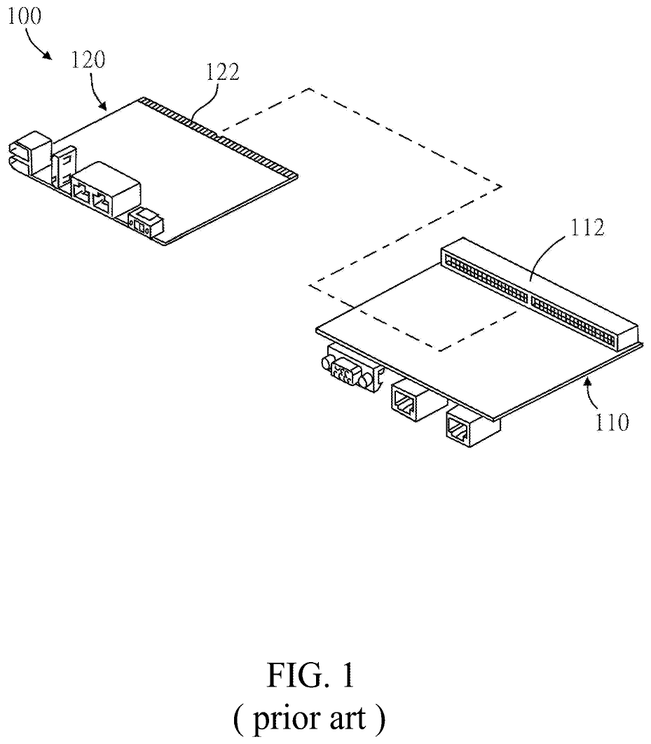

FIG. 2 is a schematic view of an expansion board according to an embodiment of the present disclosure.

FIG. 3 is a schematic view of a mainframe apparatus according to an embodiment of the present disclosure.

FIG. 4 is a diagram of pin definitions of a first connector that conforms to a USB Type-C specification according to an embodiment of the present disclosure.

FIG. 5 is a schematic view of an expansion board according to an embodiment of the present disclosure.

### DETAILED DESCRIPTION OF THE INVENTION

The disclosure is depicted by the accompanying drawings and hereafter described in detail. The terms “above,” “below,” “left” and “right” used hereafter refer to relative positions of two components only but place no limitation on the actual positions of the components. Furthermore, the verb “couple” used hereafter refers to fixedly connecting or movably connecting at least two components, including direct connection, indirect connection, and signal transmission.

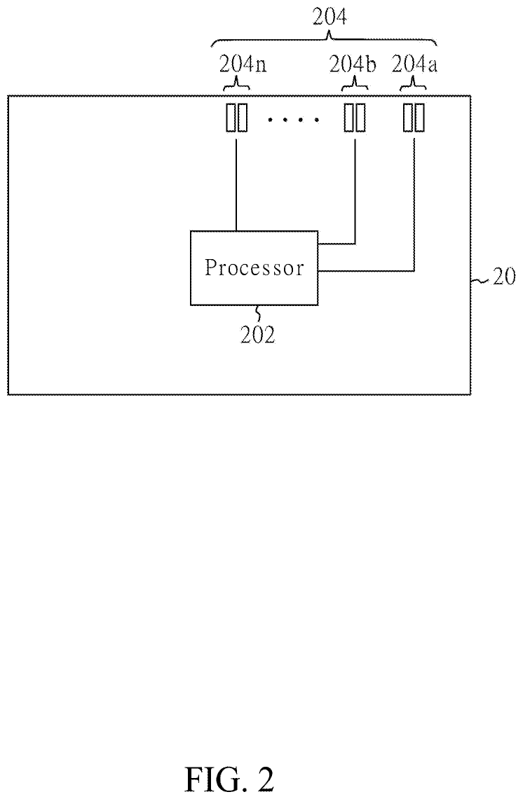

Refer to FIG. 2, which is a schematic view of an expansion board according to an embodiment of the present disclosure. An expansion board 20 that is provided in this embodiment comprises at least one group of connector pins 204. In some embodiments, the expansion board 20 comprises a plurality of groups of connector pins, such as connector pins 204a, 204b, and 204n. The connector pins 204a, 204b, and 204n are disposed at bonding pads on the expansion board 20. Pin definitions of the connector pins 204a, 204b and 204n conform to a second industrial specification, such as a PCIe signal transmission specification. Persons skilled in the art understand that the expansion board 20 further has other bonding pads, but the disclosure is not limited thereto.

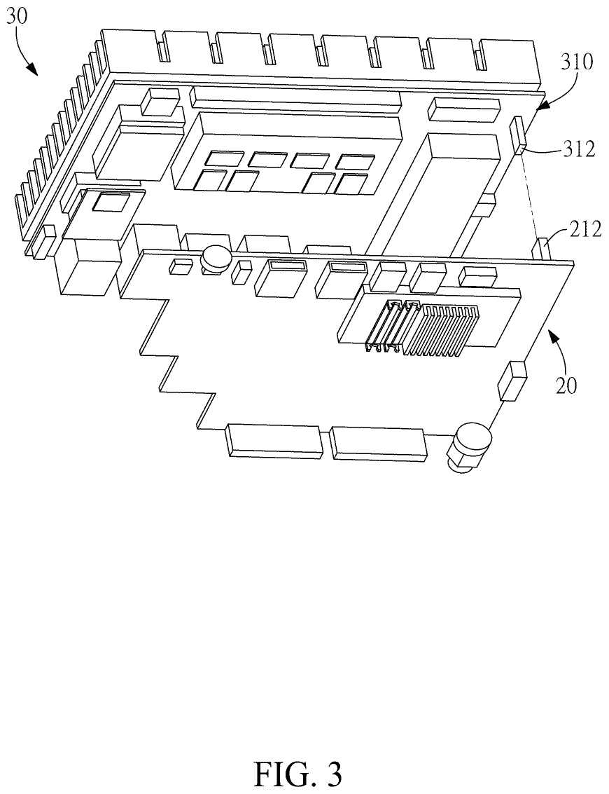

Referring to FIG. 2, the expansion board 20 further comprises a processor 202, such as a PCIe processor. The processor 202 is coupled to one end of each of the connector pins 204a, 204b, and 204n. The other end of each of the connector pins 204a, 204b, and 204n is coupled to a first connector (for example, a first connector 212 in FIG. 3) that conforms to a first industrial specification. Thus, via the connector pins 204a, 204b, and 204n, the processor 202 and the first connector that conforms to the first industrial specification exchange with each other a transmission signal that conforms to the second industrial specification, for example, a transmission signal of the PCIe transmission specification. In particular, dimensions of the first connector are less than dimensions of a second connector (for example, the connector 112) that conforms to the second industrial specification.

In an embodiment, the first connector that conforms to the first industrial specification is a male connector plug or a female connector jack.

In an embodiment, the second industrial specification supports a plurality of transmission channels, and the pin definitions of the connector pins 204 support at least one of the transmission channels, respectively.

The first industrial specification is, for example, a USB Type-C connector specification, and the second connector that conforms to a PCIe specification can be a high-speed board-to-board connector. Although the pin definitions of the connector pins 204 adopt the PCIe transmission specification, the pins of the first connector can be redefined (as described later) and thus coupled to the connector pins, thereby allowing the processor 202 to exchange signals with the first connector via the connector pins.

Refer to FIG. 3, which is a schematic view of a mainframe apparatus according to an embodiment of the present disclosure. A mainframe apparatus 30 provided in this embodiment comprises a motherboard 310 adapted to be electrically connected in parallel to the expansion board 20. In an embodiment, the motherboard 310 has the same framework as the expansion board 20 and thus is, for the sake of brevity, not described in detail again hereafter. In some embodiments, the motherboard 310 has a second connector 312 (for example, a USB Type-C connector) that conforms to the first industrial specification and corresponds in position to the first connector 212 (for example, a USB Type-C connector) disposed on the expansion board 20. Therefore, the expansion board 20 and the motherboard 310 exchange transmission signals with each other via the first connector 212 and the second connector 312.

In an embodiment, the second connector 312 on the motherboard 310 is a male connector plug (or a female connector jack), whereas the first connector 212 on the expansion board 20 is a female connector jack (or a male connector plug). In the embodiments, a direction of extension of the first connector 212 and the second connector 312 is perpendicular to planes where the expansion board 20 and the motherboard 310 lie.

Given the insignificant dimensions of the first connector 212 and the second connector 312 (for example, USB Type-C connectors) on the expansion board 20 and the motherboard 310, the first connector 212 and the second connector 312 take up little space above the expansion board 20 and the motherboard 310. Preferably, manufacturers may house the first connector 212 or the second connector 312 in broken space above the expansion board 20 or the motherboard 310. Therefore, a circuit layout of the expansion board 20 or the motherboard 310 is so flexible that the expansion board 20 or the motherboard 310 can be designed to meet user needs.

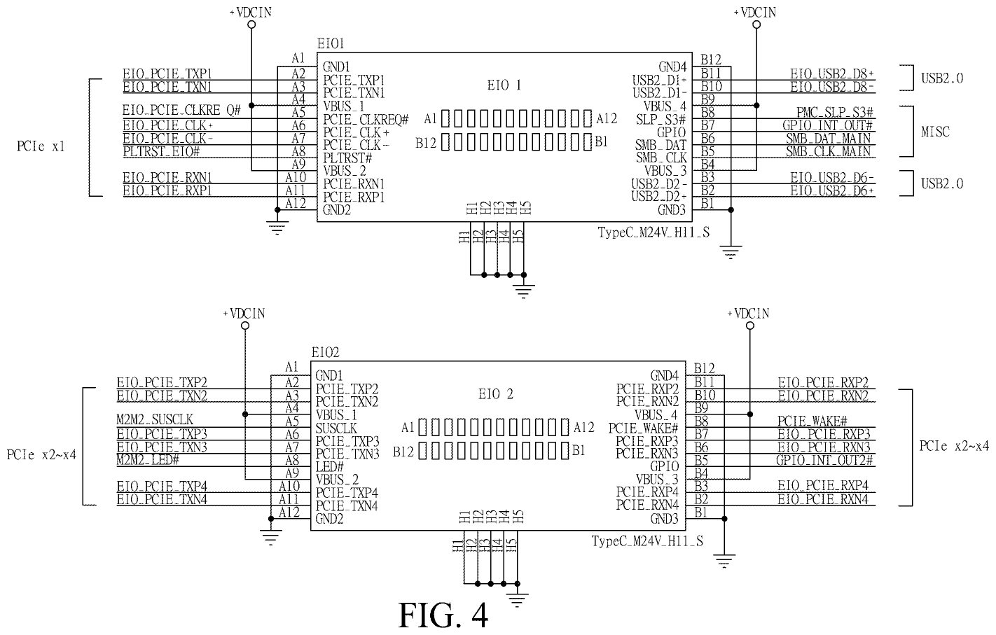

Refer to FIG. 4, which is a diagram of pin definitions of the first connector according to an embodiment of the present disclosure. The pins of the first connector have to be redefined in order for the first connector to be coupled to the connector pins that conform to the second industrial specification. In this embodiment, connectors EIO 1 and EIO 2 are the first connector 212 or the second connector 312. The connectors EIO 1 and EIO 2 are each coupled to one or more groups of connector pins, for example, the connector pins 204a-204n in FIG. 2, and are, for the sake of brevity, not reiterated hereafter. In this embodiment, pins A2, A3 of connector EIO 1 are coupled to the first group of connector pins so that PCIe transmission signals can be sent to the processor 202 via the first group of connector pins. Likewise, pins A10, A11 of connector EIO 1 can be coupled to the first group of connector pins so that the first group of connector pins receives the PCIe transmission signals from the processor 202. Therefore, the processor 202 can exchange the first group of PCIe transmission signals with connector EIO 1 via the connector pins.

Likewise, pins A2, A3, B10, and B11 of connector EIO 2 are coupled to the second group of connector pins to exchange the second group of PCIe transmission signals with the processor 202. Likewise, pins A6, A7, B6, and B7 of connector EIO 2 are coupled to the third group of connector pins to exchange the third group of PCIe transmission signals with the processor 202. Likewise, pins A10, A11, B2, and B3 of connector EIO 2 are coupled to the fourth group of connector pins to exchange the fourth group of transmission signals with the processor 202. The aforesaid interaction between the processor 202 and connector EIO 2 is similar to the interaction between the processor 202 and connector EIO 1 and thus is, for the sake of brevity, not reiterated hereafter.

In some embodiments, in addition to the PCIe processor 202, the expansion board 20 has thereon a USB processor for controlling a USB connector disposed on the expansion board 20 to send a USB signal to the motherboard 310 via the first connector 212. In the embodiment illustrated by FIG. 4, pin B2 and pin B3 of connector EIO 1 are coupled to the first group of USB connector pins, whereas pin B10 and pin B11 of connector EIO 1 are coupled to the second group of USB connector pins. Therefore, connectors EIO 1 and EIO 2 exchange four groups of PCIe transmission signals with the processor 202 and exchange two groups of USB transmission signals with the USB processor.

The aforesaid pin definitions of connectors EIO 1 and EIO 2 are illustrative rather than restrictive of the disclosure. Persons skilled in the art understand that no change made by any person to the pin definitions of the connectors EIO 1 and EIO 2 shall affect the principal spirit of the disclosure.

In some embodiments, if the processor 202 needs to send or receive less than four groups of PCIe transmission signals, it will be feasible for the expansion board 20 or the motherboard 310 to be equipped with either connector EIO1 or connector EIO 2. In other words, if the processor 202 needs to send or receive at least four groups of PCIe transmission signals, it will be feasible for the expansion board or the motherboard 310 to be equipped with both connector EIO1 and connector EIO 2. However, the disclosure is not limited thereto.

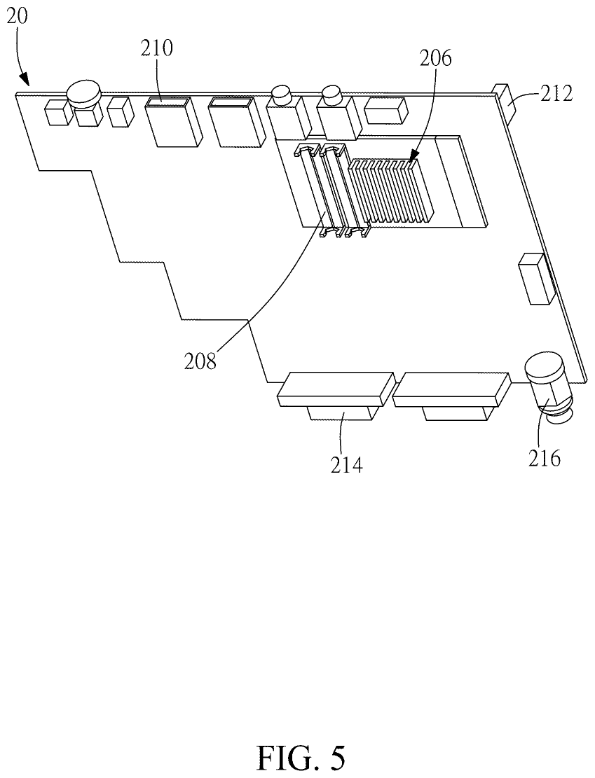

Refer to FIG. 5, which is a schematic view of an expansion board according to an embodiment of the present disclosure. In some embodiments, in addition to the USB connector, the expansion board 20 further has a mini PCIe slot 206 whereby another component is insertedly disposed on the expansion board 20.

Furthermore, in this embodiment, with the transmission signals being transmitted by the expansion board 20 via the first connector 212, the space above the expansion board 20 can be put into use effectively. For example, an Ethernet connector 208 is disposed on the expansion board 20. Furthermore, the expansion board 20 can come with a front panel jack 210 coupled to a controller of a front panel by a cable. In the embodiments, the controller of the front panel can respond to operation of the USB jack 2.0 exposed from the front panel and/or an audio input unit, an audio output unit, an LED indicator, a reboot button, and a power button on the front panel.

In some embodiments, the expansion board 20 further has a serial jack 214, for example, RS232, RS422, and/or RS485 jack.

The power of the expansion board 20 is transmitted by the second connector 312 (for example, a USB Type-C connector) and supports the specification of maximum 20V/5A. Thus, the expansion board 20 further has a special voltage input unit 216 for receiving a voltage of a wide level range, say, 9V to 36V, to meet special needs, for example, the need for on-board power, but the disclosure is not limited thereto.

Referring again to FIG. 3, although the aforesaid embodiments disclose that the motherboard 310 has the same structure as the expansion board 20, persons skilled in the art understand that the motherboard 310 may further have any other chips, heat dissipation modules, and/or I/O modules, but the disclosure is not limited thereto.

In conclusion, the connector pins on the motherboard or the expansion board are coupled to the first connector or the second conductor of small size to not only save space in an electronic device but also to ensure high signal transmission speed, so as to facilitate customization in terms of the trend toward light, small, and thin electronic devices.

Furthermore, since the pins of the first connector can be redefined by users, the user can change a number of the first connectors as needed. Even if the number of the first connectors is increased, the first connectors will not take up much space above the expansion board or the motherboard.

What is claimed is:

1. An expansion board adapted to be electrically connected in parallel to a motherboard, the expansion board comprising:
at least one group of connector pins adapted to be coupled to a first connector that conforms to a first industrial specification to receive a transmission signal from the motherboard, wherein pin definitions of the at least one group of connector pins conform to pin definitions of a second industrial specification, and the transmission signal conforms to the second industrial specification; and
a processor coupled to the at least one group of connector pins to receive or send the transmission signal,
wherein dimensions of the first connector are less than dimensions of a second connector that conforms to the second industrial specification.

2. The expansion board as claimed in claim 1, wherein the first connector is a USB Type-C connector.

3. The expansion board as claimed in claim 1, wherein the second industrial specification is a PCIe transmission specification.

4. The expansion board as claimed in claim 1, wherein a direction of extension of the first connector and a plane where the expansion board lies are perpendicular to each other.

5. The expansion board as claimed in claim 1, wherein the second industrial specification supports a plurality of transmission channels, and pin definitions of the connector pins support at least one of the transmission channels, respectively.

6. The expansion board as claimed in claim 1, wherein the first connector is a male connector plug or a female connector jack.

7. The expansion board as claimed in claim 1, wherein the processor is a PCIe processor or a USB processor.

8. A mainframe apparatus, comprising:
a motherboard adapted to be electrically connected in parallel to an expansion board;
at least one group of connector pins disposed on the motherboard and adapted to be coupled to a connector that conforms to a first industrial specification to receive a transmission signal from the expansion board, wherein pin definitions of the at least one group of connector pins conform to pin definitions of a second industrial specification, wherein the transmission signal conforms to the second industrial specification; and
a processor coupled to the at least one group of connector pins to receive or send the transmission signal,
wherein dimensions of the connector are less than dimensions of a second connector that conforms to the second industrial specification.

9. The mainframe apparatus as claimed in claim 8, wherein the connector is a USB Type-C connector.

10. The mainframe apparatus as claimed in claim 8, wherein the second industrial specification is a PCIe transmission specification.

11. The mainframe apparatus as claimed in claim 8, wherein a direction of extension of the connector and a plane where the motherboard lies are perpendicular to each other.

12. The mainframe apparatus as claimed in claim 8, wherein the second industrial specification supports a plurality of transmission channels, and pin definitions of the connector pins support at least one of the transmission channels, respectively.

13. The mainframe apparatus as claimed in claim 8, wherein the connector is a male connector plug or a female connector jack.

14. The mainframe apparatus as claimed in claim 8, wherein the processor is a PCIe processor or a USB processor.
